(19) United States
(12) Patent Application Publication
(10) Pub. No.: US 2024/0166315 A1
(43) Pub. Date: May 23, 2024

(54) MONITORING THE CLEANLINESS OF AN UNDERWATER SURFACE OF A STATIONARY OBJECT

(71) Applicant: Jotun A/S, Sandefjord (NO)

(72) Inventors: Joana Costa, Sandefjord (NO); Andreas Krapp, Sandefjord (NO); Sergiu Paereli, Sandefjord (NO); Kjartan Tobias Boman, Sandefjord (NO); Seamus Michael Jackson, Sandefjord (NO); Manolis Levantis, Sandefjord (NO)

(21) Appl. No.: 18/551,072

(22) PCT Filed: Mar. 23, 2022
(86) PCT No.: PCT/EP2022/057632

§ 371 Date: Sep. 18, 2023

(30) Foreign Application Priority Data
Mar. 23, 2021 (EP) 21386022.4
Jul. 6, 2021 (EP) 21386042.2

(51) Int. Cl. B63B 59/04; B63B 59/08; B63B 79/10; B63G 8/00

(52) U.S. Cl. CPC B63B 59/04; B63B 59/08; B63B 79/10; B63G 8/001; B63G 2008/005

(57) ABSTRACT

A computer implemented method of monitoring the cleanliness of an underwater surface of a stationary object. The method is performed on a computing device and comprises: retrieving environmental data from memory of the computing device, the environmental data associated with environment conditions of the stationary object; determining a fouling value indicative of a level of fouling that the surface is exposed to based on at least the environmental data; determining a fouling protection value defining a tolerance to fouling associated with a surface of the stationary object; and identifying a level of risk of fouling on the surface of the stationary object by determining a fouling risk value using the fouling protection value and the fouling value.

### TECHNICAL FIELD

The present disclosure relates to monitoring the cleanliness of an underwater surface of a stationary object.

### BACKGROUND

All surfaces immersed in seawater will experience fouling of organisms such as bacteria, diatoms, algae, mussels, tube worms and barnacles. Marine fouling is the undesirable accumulation of microorganisms, algae and animals on structures immersed in seawater. The fouling organisms can be divided into microfouling (bacterial and diatomic biofilms) and macrofouling (e.g. macroalgae, barnacles, mussels, tubeworms, bryozoans) which live together forming a fouling community. In a simplistic overview of the fouling process, the first step is the development of a conditioning film where organic molecules adhere to the surface. This happens instantaneously when a surface is immersed in seawater. The primary colonizers, the bacteria and diatoms, will settle within a day. The secondary colonizers, spores of macroalgae and protozoa, will settle within a week. Finally, the tertiary colonizers, the larvae of macrofouling, will settle within 2-3 weeks.

The development of marine fouling is a known problem. Fouling of stationary man-made objects immersed in seawater will lead to increased structural load due to increases in weight and diameter of the installation as well as increased wave and current load due to increased roughness of the surface and increased volume of the structure. This will give less stability of the structure which must be avoided. The fouling organisms can also grow into the coating film and damage the coating film which can lead to corrosion. This is detrimental as the structure can lose its strength and collapse.

The fouling protection of stationary man-made objects are usually made by applying antifouling coatings or other type of coatings in combination with cleaning.

### SUMMARY

When offshore installations, e.g. for oil, gas, wind, tidal and fish farming, are manufactured it is decided how the fouling protection should be obtained. Either an antifouling coating or another type of coating together with cleaning is chosen. The lifetime of these objects can be as long as 20 years or even longer. During this time it is impossible to maintain or change the coating applied to the parts immersed in water.

Coatings are usually specified according to the environment where the stationary object will be. However, before installation the location of where the stationary object will be can be changed after the manufacturing and coating application. The lifetime of an antifouling coating is usually around 3-7 years but the lifetime varies as it is influenced by environmental factors that varies both seasonally and yearly. When the lifetime of the coating is exceeded the immersed parts are unprotected against fouling.

The inventors have identified that it is difficult to design and specify a coating and a cleaning schedule to maintain a sufficient fouling protection during the entire lifetime of stationary objects. Inspections of offshore installations cost time and resources so it is desirable to make as few inspections as possible.

Therefore, a monitoring system is needed to be able to monitor a stationary object and predict when there is a risk of fouling to ensure that the correct actions are made in due time.

According to another aspect of the present disclosure there is provided a computer implemented method of monitoring the cleanliness of an underwater surface of a stationary object, the method performed on a computing device and comprising: retrieving environmental data from memory of the computing device, the environmental data associated with environment conditions of the stationary object; determining a fouling value indicative of a level of fouling that the surface is exposed to based on at least the environmental data; determining a fouling protection value defining a tolerance to fouling associated with a surface of the stationary object; and identifying a level of risk of fouling on the surface of the stationary object by determining a fouling risk value using the fouling protection value and the fouling value.

The environmental data may comprises a value associated with each of one or more environmental parameters.

The environmental data may relate to a geographical location of the stationary object.

The environmental data may be sensed by at least one of: one or more sensors on the stationary object: one or more sensors on a cleaning robot configured to clean the surface of the stationary object; one or more sensors on a remotely operated underwater vehicle configured to inspect the surface of the stationary object.

Environmental data relating to multiple geographical locations may be stored in the memory, and the environmental data relating to the geographical location of the stationary object may be retrieved using the geographical location of the stationary object.

The fouling value may be an instantaneous fouling value indicative of a level of fouling that the surface is exposed to at a sampling time, the instantaneous fouling value may be determined by computing a weighted average of values of a plurality of risk parameters, the plurality of risk parameters comprising at least one environmental parameter defined in the environmental data.

The fouling risk value may be determined based on: (i) a plurality of instantaneous fouling risk values, each of the plurality of instantaneous fouling risk values identifying a level of risk of fouling on the surface of the stationary object at a respective sampling time in a time period, and (ii) a time factor relating to said time period.

The method may further comprise identifying high risk fouling conditions by determining that the fouling risk value exceeds a predetermined threshold, and in response outputting a control signal

The method may further comprise outputting the fouling risk value.

The method may further comprise outputting the fouling risk value to an output device of said computing device or outputting the fouling risk value to a remote computing device.

The method may further comprise outputting a control signal in dependence on receiving user confirmation that a control action is to be performed.

The method may comprise outputting the control signal to a remotely operated underwater vehicle or a cleaning robot configured to clean the surface of the stationary object, to initiate inspection of the surface of the stationary object.

The method may comprise outputting the control signal to an output device of the computing device or to a remote device on said stationary object to alert a user to initiate inspection of the surface of the stationary object.

The method may comprise outputting the control signal to a cleaning robot configured to clean the surface of the stationary object, to initiate cleaning of the surface of the stationary object.

The stationary object or an on-shore monitoring station may comprise the computing device.

The computing device may be a cleaning robot configured to clean the surface of the stationary object, and method comprises: outputting the control signal to an inspection device of the cleaning robot to initiate inspection of the surface of the stationary object; or outputting the control signal to a cleaning device of the cleaning robot to initiate cleaning of the surface of the stationary object.

Outputting of the control signal may be further based on receiving user confirmation that a control action is to be performed.

The fouling protection value may be determined based on a value defining an attractiveness of the surface to fouling.

The value defining an attractiveness of the surface to fouling is determined based on one or more of (i) a surface energy of the surface, (ii) a topography of the surface, (iii) a porosity of the surface, (iv) an elasticity of the surface, and (v) a colour of the surface.

The fouling protection value may be determined based on a value defining an effect, on the surface, of water moving over said surface.

The value defining an effect, on the surface, of water moving over said surface may be determined using a speed of water, and one or more of (i) a surface energy of the surface, (ii) a topography of the surface, and (iii) a porosity of the surface.

A coating providing the surface may be a polishing coating and the value defining an effect, on the surface, of water moving over said surface may be determined using a polishing rate associated with said coating.

A coating providing the surface may comprise a fouling control agent, and the fouling protection value may be determined based on a value defining an effect of the fouling control agent.

The one or more environmental parameters may comprise one or more of: (i) a parameter relating to a temperature of an aquatic environment of the stationary object; (ii) a parameter relating to a water depth of the aquatic environment of the stationary object; (iii) a parameter relating to a distance between the stationary object and coastline; (iv) a parameter relating to a length of day; (v) a parameter relating to a light intensity in the aquatic environment; (vi) a parameter relating to an amount of chlorophyll in the aquatic environment; (vii) a parameter relating to a salinity level of the aquatic environment; (viii) a parameter relating to a pH level of the aquatic environment; (ix) a parameter relating to a nutrient level in the aquatic environment; (x) a parameter relating to an amount of carbon dioxide in the aquatic environment; (xi) a parameter relating to an amount of gaseous oxygen dissolved in water in the aquatic environment; and (xii) a parameter relating to a speed of water in the aquatic environment.

The method may be performed periodically.

According to another aspect of the present disclosure there is provided a computer-readable storage medium comprising instructions which, when executed by a processor of a computing device, cause the processor to carry out any of the methods described herein.

The instructions may be provided on a carrier such as a disk, CD- or DVD-ROM, programmed memory such as read-only memory (Firmware), or on a data carrier such as an optical or electrical signal carrier. Code (and/or data) to implement embodiments of the present disclosure may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language.

According to another aspect of the present disclosure there is provided a computing device for monitoring the cleanliness of an underwater surface of a stationary object, the computing device comprising a processor configured to perform any of the methods described herein.

### BRIEF DESCRIPTION OF THE DRAWINGS

For a better understanding of the present disclosure and to show how embodiments may be put into effect, reference is made to the accompanying drawings in which:

FIG. 1a illustrates a stationary object and a robot;

FIG. 1b illustrates a monitoring station in communication with a group of stationary objects;

FIG. 2 is a schematic block diagram of the robot;

FIG. 3 is a schematic block diagram of a computing device;

FIG. 4 illustrates a method for monitoring the cleanliness of an underwater surface of a stationary object;

FIGS. 5a and 5b illustrate methods of determining a fouling value;

FIG. 6a illustrates how values of environmental parameters may vary over time;

FIG. 6b illustrates how the fouling value may vary over time:

FIG. 7a illustrates the contribution of a speed of water parameter to the fouling value;

FIG. 7b illustrates the contribution of a sea surface water temperature parameter to the fouling value:

FIG. 7c illustrates the contribution of a distance to coastline parameter to the fouling value;

FIG. 8a illustrates example control actions that may be performed in embodiments of the present disclosure in response to user confirmation that action is to be taken in response to the cleanliness of an underwater surface of a stationary object being monitored;

FIG. 8b illustrates example control actions that may be performed in embodiments of the present disclosure automatically in response to the cleanliness of an underwater surface of a stationary object being monitored;

FIG. 8c illustrates example control actions that may be performed in embodiments of the present disclosure by a cleaning robot in response to user confirmation that action is to be taken in response to the cleanliness of an underwater surface of a stationary object being monitored;

FIG. 8d illustrates example control actions that may be performed in embodiments of the present disclosure by a cleaning robot automatically in response to the cleanliness of an underwater surface of a stationary object being monitored; and

FIG. 9 illustrates an example cleaning robot.

### DETAILED DESCRIPTION

Embodiments will now be described by way of example only.

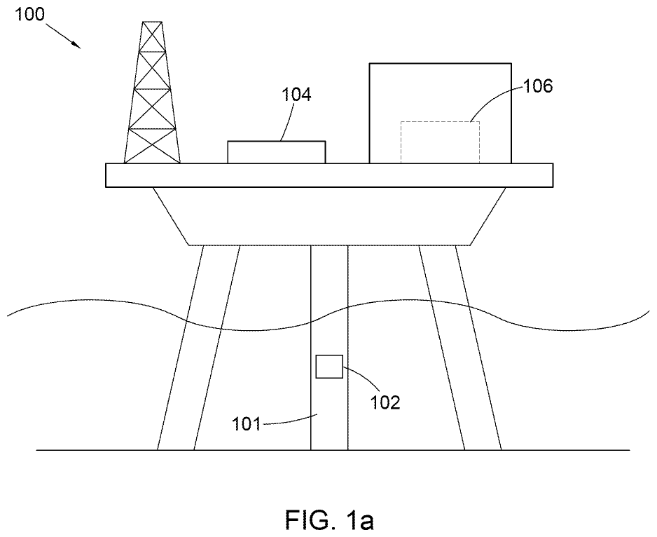

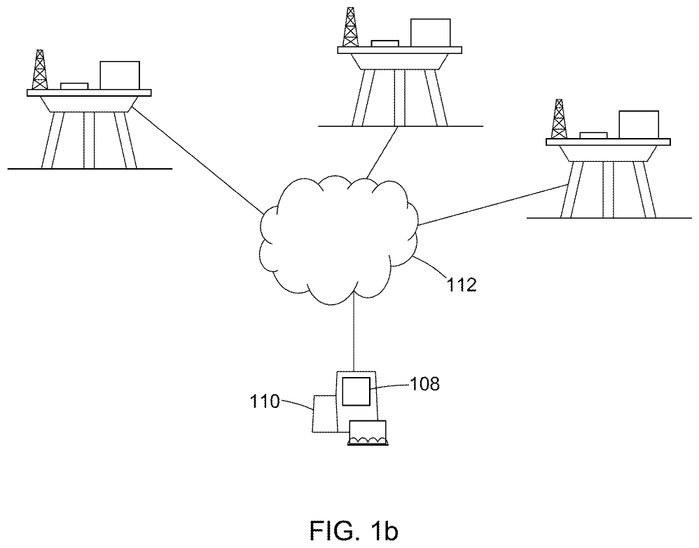

FIG. 1a illustrates an example stationary object 100 in the form of an offshore oil platform The stationary object 100 comprises a surface 101 immersed (i.e. submerged) in water such that it is under the surface of the water.

We refer to a “stationary object” as a man-made object that is partially or fully immersed in water such that it has at least one surface immersed in water. A stationary object may be located in a salt water or fresh water aquatic environment which may for example be a river, sea, ocean, fjord etc. A stationary object does not move during use. Stationary objects may have self-propulsion mechanism such as an engine, motor or the like but the self-propulsion mechanism is only used if the position where the stationary object is operating should be changed.

A stationary object may be fixed to the ground at the bottom of the aquatic environment (e.g. a sea bed) by a permanent structure, for example the stationary object may be a oil and/or gas platform, oil and/or gas rig, a wind turbine, a bridge, an underwater cable or an underwater pipe etc. It will be appreciated that the permanent structure prevents any movement of the stationary object.

A stationary object may be an object floating on the surface of the water. For example, the stationary object may be a permanently moored ship, a floating production storage and offloading facility (FPSO), a floating storage and offloading unit (FSO), a fish farm, or a buoy. Thus, it will be appreciated that such stationary objects may move by virtue of water currents, tides and/or environmental conditions (e.g. wind) or moved to a different location if change of operations requires it.

In some examples, a stationary object floating on the surface of the water may be fixed to the ground at the bottom of the aquatic environment by a non-permanent tethering means (e.g. a rope, chain or cable attached to an anchor).

The stationary object may comprise a robot station 104 (a docking station) which may be used to charge a cleaning robot 102. The robot station 104 may be positioned on the stationary object above the sea level. The robot station 104 may allow for parking of the robot 102 when cleaning operations performed by the robot are paused. During cleaning of the surface 101 immersed in water of the stationary object 100, the robot 102 may traverse any surface of the stationary object 100 where marine fouling may form (e.g. pillars or pile for windmills and oil rigs). Reference to “cleaning” is used herein to refer to the removal of fouling organisms from the surface 101 of the stationary object 100, such cleaning is sometimes referred to as “grooming”. By performing the continual cleaning of the surface 101 of the stationary object 100, the robot 102 typically performs removal of fouling at an early stage (e.g. primary and secondary colonizers) that has adhered to the surface 101 of the stationary object 100. However, it will be appreciated that the cleaning performed by the robot 102 may also involve removal of tertiary colonizers and any subsequent colonizers.

As shown in FIG. 1a, a computing device 106 may be provided on the stationary object (e.g. in a deckhouse of the stationary object) for communication with a remote device such as the robot 102 and/or a computing device 108 on shore e.g. at a monitoring station 110 as shown in FIG. 1b.

FIG. 1b illustrates such a monitoring station 110 comprising a computing device 108. The computing device 108 is in communication with one or more stationary objects via a communication network 112.

In embodiments of the present disclosure, a computer implemented method for monitoring the cleanliness of a surface immersed in water of a stationary object is performed. As will be explained in more detail below, this method may be performed on the robot 102, the computing device 106 on the stationary object, or the on-shore computing device 108.

As shown in FIG. 1b, in implementations where an on-shore computing device 108 performs the computer implemented method described herein, this enables an operator of a stationary object to have real time monitoring over the surface condition of the immersed areas of the stationary object.

Embodiments of the present disclosure are not limited to monitoring the cleanliness of a surface immersed in water of a stationary object which is equipped with a cleaning robot 102. As will be explained in more detail below, in response to detecting that such stationary objects are at high risk of fouling on the surface of the stationary object, other actions not involving a cleaning robot can be taken in response to the detection.

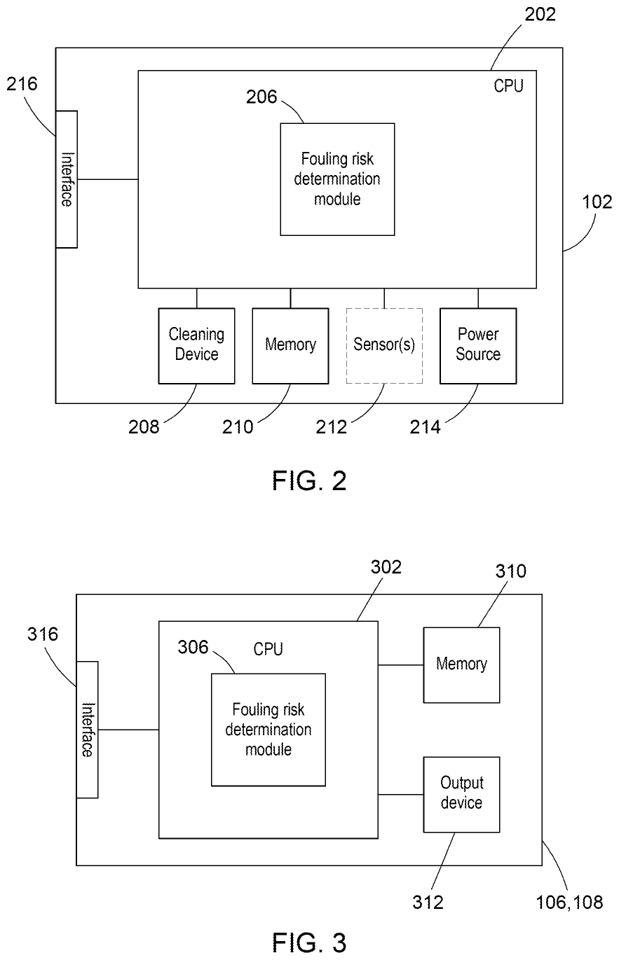

FIG. 2 is a schematic block diagram of the robot 102. As shown in FIG. 2, the robot 102 is a computing device comprising a central processing unit (“CPU”) 202. The CPU 202 is configured to control a cleaning device 208 (which may take the form of a rotary cylindrical brush) which is coupled to the CPU 202 and performs the removal of fouling organisms from an underwater surface 101 of the stationary object 100.

The CPU 202 may also comprise a fouling risk determination module 206 that is configured to monitor the cleanliness of a surface 101 immersed in water of a stationary object 100 in accordance with embodiments of the present disclosure. The fouling risk determination module 206 may be configured to dynamically monitor the cleanliness of the underwater surface 101 It will be apparent from the below that whilst the robot 102 may comprise the fouling risk determination module 206, in alternative embodiments the fouling risk determination module 206 may be a component of computing device external to the robot 102.

The CPU 202 is coupled to a power source 214 (e.g. one or more battery). The power source 214 may be rechargeable e.g. using the robot station 104. The robot 102 also comprises a memory 210 for storing data as is known in the art.

As shown in FIG. 2, the robot 102 may comprise one or more sensor 212 that are configured to output a sensor signal to the fouling risk determination module 206. Each of the sensors described herein may be a physical sensor (i.e. a physical measurement instrument) or a virtual sensor (i.e. software that combines sensed data from multiple physical sensors to compute a measurement).

The sensor(s) 212 may comprise one or more sensors configured to sense environmental data relating to the environment conditions of the stationary object 100.

For example, the sensor(s) may comprise one or more of: (i) a chlorophyll sensor configured to sense an amount of chlorophyll in an aquatic environment of the stationary object; (ii) a pH sensor configured to sense a pH level of the aquatic environment of the stationary object; (iii) a nutrients sensor configured to sense a nutrient level in the aquatic environment of the stationary object, the nutrients sensor may be configured to sense nutrients such as phosphate, nitrate etc.; (iv) a sunlight intensity sensor configured to sense a light intensity in the aquatic environment of the stationary object; (v) a salinity sensor (e.g. a conductivity sensor) configured to sense a saline level of the aquatic environment of the stationary object; (vi) a temperature sensor configured to sense a temperature of the aquatic environment of the stationary object; (vii) a carbon dioxide sensor configured to sense an amount of carbon dioxide in the aquatic environment of the stationary object; (viii) a location sensor (e.g. a GPS sensor) configured to sense a geographical location of the stationary object; (ix) a dissolved oxygen sensor configured to sense an amount of gaseous oxygen dissolved in the water in the aquatic environment of the stationary object: (x) a depth sensor configured to sense a depth of the aquatic environment of the stationary object; and (xi) a water speed sensor configured to sense the speed of the water in the aquatic environment of the stationary object 100. Such sensors are known to persons skilled in the art and are therefore not described in further detail herein.

The location sensor referred to above can be used to determine the distance between the stationary object and nearby coastline.

Multiple sensors of the same type may be used in embodiments of the present disclosure. For example, multiple temperature sensors may be used to measure the temperature of the aquatic environment of the stationary object at different depths. In embodiments, the readings from multiple sensors of the same type may be combined to provide a single value associated with the sensor type.

Whilst the sensor(s) referred to above have been described as being located on the robot 102, these sensors may located external to the robot. For example, these sensors may be located on a remotely operated underwater vehicle configured to inspect the surface immersed in water of the stationary object, these sensors may be located on the stationary object 100, or these sensors may be located on another object in the same aquatic environment as the stationary object 100.

The sensor(s) that are located on the stationary object 100 may output the data directly to the fouling risk determination module 206 on the robot 102 via interface 216. Alternatively, the sensor(s) that are located on the stationary object 100 may output data to the computing device 106 which relays the data to the robot 102 via interface 216.

The sensor(s) 212 may comprise a camera configured to output a camera signal comprising image data. The camera may output the camera signal to the computing device 106 and/or computing device 108. The camera enables the robot 102 to carry out a visual inspection of the surface 101 of the stationary object 100. The robot 102 may inspect the surface 101 of the stationary object without carrying out a visual inspection. Thus, in addition to or as an alternative to the camera, the robot 102 may comprise one or more other inspection device for carrying out an inspection of the surface immersed in water such as electromagnetic device or ultrasound device.

In some embodiments an interface 216 is provided to enable the robot 102 to receive and transmit data to the computing device 106 and the computing device 108. The interface 216 also enable the robot to receive data from sensors on the stationary object. The interface 216 may comprise a wired and/or a wireless interface.

As noted above, in some embodiments the fouling risk determination module is a component of a computing device 106 on the stationary object, or an on-shore computing device 108. FIG. 3 illustrates such a computing device.

As shown in FIG. 3, the computing device 106,108 comprising a central processing unit (“CPU”) 302. The CPU 302 is coupled to a memory 310 for storing data as is known in the art and an output device 312.

The CPU 302 may also comprise a fouling risk determination module 306 that is configured to monitor the cleanliness of an underwater surface of a stationary object in accordance with embodiments of the present disclosure.

The computing device 106, 108 comprising an interface 316 to enable the computing device to receive and transmit data. The interface 316 enables the computing device 106,108 to receive data from the robot 102 (if one is present on the stationary object). and/or receive data from sensors on the stationary object. For example, the computing device may receive the environmental data referred to above via the interface 316. The interface 316 also enables the computing device to communicate with the robot 102 and/or a remotely operated underwater vehicle on the stationary object

The output device 312 is configured to output information to a user of the computing device 106,108. For example the output device 312 may comprise a display to visually output information. Additionally or alternatively, the output device 312 may comprise a speaker to audibly output information.

The use of the environmental data referred to above is not limited to any particular embodiment described herein, and may be used in all embodiments.

In embodiments of the present disclosure, the cleanliness of a surface immersed in water of a stationary object may be dynamically monitored.

The surface immersed in water of a stationary object is typically coated. The coating present on the surface of the stationary object may comprise a single layer, several layers of the same coating or may be a multi-layered coating, i.e. a coating system. In a multi-layered coating, the first coat (sometimes referred to as the primer coating) is often an anticorrosive layer. The primer coating is optionally over coated by a link coat or tie-coat followed by one or more final coats or topcoats, with or without fouling protection properties. In another type of multi-layered coating, the first (primer) coat may simply be over coated with a last coat or topcoat.

The surface of parts of the stationary object that are to be immersed in water may be coated with a single coating or coating system. Alternatively, the surface of the stationary object may comprise of a number of sections of different coatings, or coating systems, on different parts of the stationary object (e.g. waterline/splash zone, vertical sectioning of pillar and piles, side and flat bottom of hulls of FPSOs). The different coatings or coating systems present in different parts of the stationary object might be different types and/or different thicknesses.

The coatings applied on the parts of the stationary object to be immersed in water can be divided in classes depending on if the coatings are polishing or non-polishing. A polishing coating is a coating that decreases in film thickness during the life-time of the coating. The reduction in film thickness may be due to chemical reactions or erosion or a combination thereof. A non-polishing coating is a coating that does not decrease in film thickness during the life-time of the coating.

Polishing coatings are typically based on binder systems with various mechanisms for degradation. Self-polishing coating is another term commonly used. Most often the degradation is hydrolysis of bonds in the binder system resulting in increased water solubility and polishing of the coating. The hydrolysis can either be hydrolysis of pendant groups or side chains on the polymer backbone in the binder or hydrolysis of groups in the polymer backbone in the binder.

The binder present in a polishing coating may, for example, comprise silyl (meth)acrylate copolymer, rosin based binder, (meth)acrylate binder, backbone degradable (meth)acrylate copolymer, metal (meth)acrylate binder, hybrids of silyl (meth)acrylate binder, (meth)acrylic hemiacetal ester copolymers, polyanhydride binder, polyoxalate binder, non-aqueous dispersion binder, zwitterionic binder, polyester binder, poly(ester-siloxane) binder, poly(ester-ether-siloxane) binder, or mixtures thereof.

Typical silyl (meth)acrylate copolymers and coatings comprising these are described in GB2558739, GB2559454, WO2019096926, GB2576431, WO2010071180, WO2013073580, WO2012026237, WO2005005516, WO2013000476, WO2012048712, WO2011118526, WO0077102, WO2019198706, WO03070832 and WO2019216413.

Typical silyl (meth)acrylate copolymers with siloxane moieties are described in WO2011046087. Typical rosin based binders and coatings comprising these are described in WO2019096928, DE102018128725, DE102018128727 and WO9744401.

Typical (meth)acrylate binders and coatings comprising these are described in DE102018128725A1, DE102018128727A1. WO2019096928, WO2018086670 and WO9744401. Typical metal (meth)acrylate binders are described in WO2019081495 and WO2011046086. Typical hybrids of silyl (meth)acrylate binders are described in KR20140117986, WO2016063789, EP1323745, EP0714957, WO2017065172, JPH10168350A and WO2016066567. Typical polyanhydride binders are described in WO2004/096927. Typical polyoxalate binders are described in WO2019081495 and WO2015114091. Typical non-aqueous dispersion binders are described in WO2019081495. Typical zwitterionic binders are described in WO2004018533 and WO2016066567. Typical polyester binders are described in WO2019081495, EP1072625, WO2010073995 and US20150141562. Typical poly(ester-siloxane) and poly(ester-ether-siloxane) binders are described in WO2017009297, WO2018134291 and WO2015082397. Typical (meth)acrylate hemiacetal ester copolymer binders are described in WO2019179917, WO2016167360, EP0714957 and WO2017065172. Typical backbone degradable (meth)acrylate copolymer binders are described in WO2015010390, WO2018188488, WO2018196401 and WO2018196542.

Non-polishing coatings are typically cross linked and often containing low amount of VOC (volatile organic compounds). The binder present in a non-polishing coating may, for example, comprise polysiloxane, a siloxane copolymer, silicone binders, an epoxy-based binder, epoxysiloxane, polyurethanes or mixtures thereof.

Typical polysiloxane binders and coatings comprising these are described in WO2019101912, WO2011076856, WO2014117786, WO2016088694 and WO2013024106. Typical siloxane copolymer binders are described in WO2012130861 and WO2013000479. Typical epoxy-based binders and coatings comprising these are described in WO2018046702, WO2018210861, WO2009019296, WO2009141438, EP3431560 and WO2017140610. Typical epoxysiloxane binders are described in US2009281207, WO2019205078 and EP1086974. Other types of silicone binders are silicone resins typically denoted as MQ, DT, MDT. MTQ or QDT resins. The coating may be a riblet structured curable polysiloxane binder, as described in WO2019189412. The coating may be a dimple structured coating as described in US20180229808. Such coatings may be applied as a coating or as an adhesive foil.

The coating may be a riblet structured adhesive foil with a fouling release topcoat, for example, as described in WO2018100108.

The coating applied on the stationary object may also be divided in classes depending on if the coating contains a fouling control agent. Fouling control agents can be organic, organometallic or inorganic compounds that influences, repels or acts hazardously towards fouling organisms.

One group of fouling control agents are biocides which are substances intended to destroy, deter, render harmless, prevent action of or exert a controlling effect towards fouling organisms by chemical or biological means. The terms biocides, antifouling agents, antifoulants, active compounds, toxicants are used in the industry to describe known compounds that act to prevent marine fouling on a surface. The biocides may be inorganic, organometallic or organic.

Commonly used biocides are copper(I)oxide, copper thiocyanate, zinc pyrithione, copper pyrithione, zinc ethylenebis(dithiocarbamate) [zineb], 2-(tert-butylamino)-4-(cyclopropylamino)-6-(methylthio)-1,3.5-triazine [cubutryne], 4,5-dichloro-2-n-octyl-4-isothiazolin-3-one [DCOIT], N-dichlorofluoromethylthio-N′,N′-dimethyl-N-phenylsulfamide [dichlorofluanid], N-dichlorofluoromethylthio-N′, N′-dimethyl-N-p-tolylsulfamide [tolylfluanid], triphenylborane pyridine [TPBP] and 4-bromo-2-(4-chlorophenyl)-5-(trifluoromethyl)-1H-pyrrole-3-carbonitrile [tralopyril] and 4-[1-(2,3-dimethylphenyl)ethyl]-1H-imidazole [medetomidine].

One group of fouling control agents that prevents or reduces attachment of fouling organisms by a physical mode of action are silicone oils, hydrophilic modified silicone oils and hydrophobic modified silicone oils. Typical silicone oils are described in WO2018/134291.

Both polishing and non-polishing coatings can contain fouling control agents such as biocides and silicone oils or mixtures thereof or be without a fouling control agent.

Embodiments of the present disclosure can be used to monitor the cleanliness of a coated surface of the stationary object (i.e. the cleanliness of a surface of a coating applied to the stationary object) or an uncoated surface of a stationary object during immersion in water.

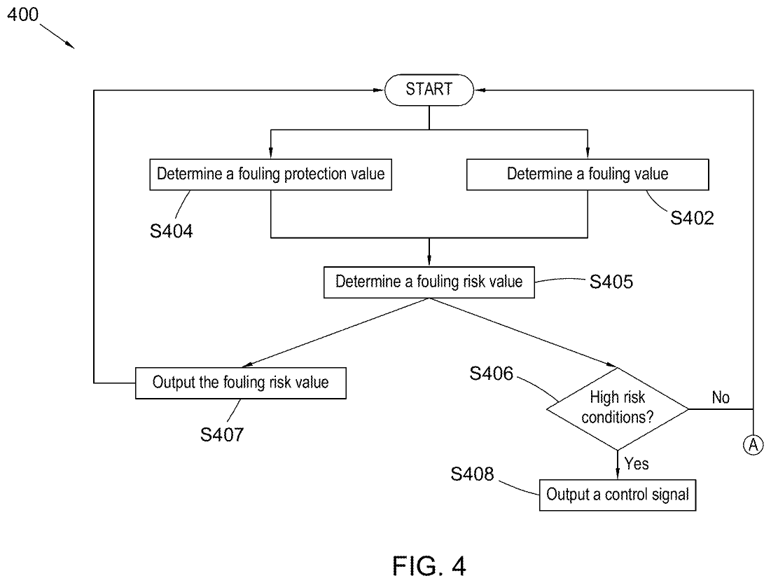

FIG. 4 illustrates a flowchart of a process 400 for monitoring the cleanliness of an underwater surface of a stationary object performed by the fouling risk determination module 206,306. Thus, the process 400 is performed by a computing device. For example, the process 400 may be performed on the robot 102, the computing device 106 on the stationary object, or the on-shore computing device 108.

The process 400 aims to predict the fouling risk that a stationary object might be exposed to during its service, which reflects on the degree of fouling that can develop or be present on the stationary object's surface immersed in water. In particular, the level of risk of fouling on a surface immersed in water of the stationary object is identified by determining a fouling risk value using a fouling protection value and a fouling value. As explained below, this fouling risk value can be considered in a normalized scale from 0 (low) to 1 (high). The fouling risk value may take any value on this normalized scale.

At step S402, the fouling value is determined. The fouling value reflects how the conditions of the environment (marine and atmospheric) of the stationary object can influence the development and growth of marine biofouling on a stationary object's surface immersed in water.

In order to determine the fouling value, the fouling risk determination module requires environmental data relating to the environment conditions of the stationary object 100, examples of which have been provided above. The environmental data comprises a value associated with each of one or more environmental parameters.

The fouling risk determination module may identify the environmental data relating to the environment conditions of the stationary object 100 in a number of different ways.

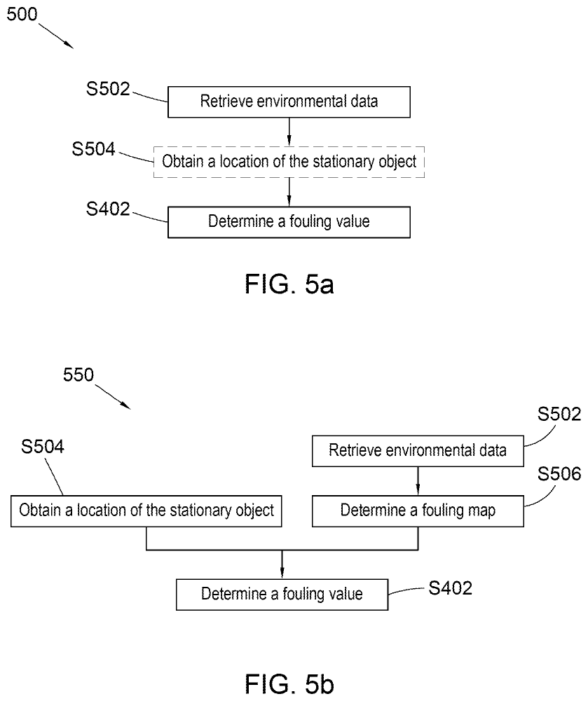

As shown in FIG. 5a, in a process 500 at step S502 the fouling risk determination module retrieves environmental data from memory (e.g. local memory of the computing device or in memory of a remote computing device that is accessible by the computing device). If the retrieved environmental data relates to the environment conditions of the stationary object 100 (e.g. the environmental data has been sensed by sensors on the robot 102 or sensors on the stationary object), the retrieved environmental data can be used at step S402 to determine the fouling value.

As shown in FIG. 5a, in the process 500 the retrieved environmental data may include but not specifically relate to the environment conditions of the stationary object 100. That is, the retrieved environmental data may relate to the environment conditions of a geographical region in which the stationary object 100 is located. The geographical region can be any size ranging from a fjord in Norway, to a coastal region of a country. to the entire planet Earth. The retrieved environmental data may be obtained from national weather services or from buoys that are equipped with measuring devices. The retrieved environmental data may be satellite derived marine environment data relating to environment conditions of the geographical region. In these scenarios, at step S504 the fouling risk determination module obtains the geographical location of the stationary object. The fouling risk determination module then uses the geographical location of the stationary object together with the retrieved environmental data of the geographical region to determine environmental data relating to the environment conditions of the stationary object 100 which is then used at step S402 to determine the fouling value. In this example the geographical location of the stationary object may have been sensed by a location sensor on the robot 102 or a location sensor (e.g. GPS sensor) on the stationary object.

As shown in FIG. 5b, in embodiments where an on-shore computer device 108 performs the process 400, in a process 550 the fouling risk determination module 306 retrieves environmental data at step S502 to determine a fouling map at step S506. The fouling map identifies the marine fouling conditions of multiple locations and may change over time. The fouling map may be a global fouling map. Alternatively, the fouling map may be a local fouling map that is focussed on particular geographical area(s) of the Earth.

The environmental data retrieved at step S502 used to determine the fouling map may comprise satellite derived marine environment data.

Additionally, or alternatively, the environmental data retrieved at step S502 used to determine the fouling map may comprise, for each of one or more stationary objects, environmental data relating to the environment conditions of the stationary object (e.g. the environmental data has been sensed by sensors on a robot on the stationary object, or sensors on the stationary object) and the geographical location of the stationary object. In this example the geographical location of the stationary object may have been sensed by a location sensor on a robot on the stationary object or a location sensor (e.g. GPS sensor)on the stationary object.

At step S504, the fouling risk determination module 306 obtains the geographical location of the stationary object that is to be monitored and uses the geographical location of the stationary object and the fouling map to determine environmental data relating to the environment conditions specific to the stationary object 100 being monitored which is then used at step S402 to determine the fouling value. In this example the geographical location of the stationary object may have been sensed by a location sensor on the robot 102 or a location sensor on the stationary object.

One or more environmental parameters are used to determine the fouling value at step S402.

As one example, expressions may be stored in memory which model the approximate risk/contribution that each parameter provides to the overall fouling value.

Such expressions may be empirically derived. To determine the marine biofouling pressure that a stationary object 100 might be exposed to at any point in time (defined by the fouling value), an amount of environment conditions (for example, surface seawater temperature, light availability, concentration of nutrients, concentration of chlorophyll, surface seawater salinity, distance to coastline, water depth), and how they may influence the condition on the stationary object's surface 101 immersed in water, were studied and analysed by the inventors of the present disclosure for several locations. Empirical results from permanent test rafts, test patches on hulls, in docking conditions and inspection reports, were compared against marine and atmospheric environment conditions gathered for the locations in question. Based on this study, empirical derived expressions were developed to model the approximate risk/contribution that each environment parameter provides to the overall fouling value.

Considering the example parameters provided below:

| | |
|---|---|
| Water speedᵣᵢₛₖ = S(t) ∈ [0.1] | Speed of water (in knots) |
| Temperatureᵣᵢₛₖ = T(t) ∈ [0.1] | Seawater surface temperature (in degrees |
| | Celsius) |
| Depthᵣᵢₛₖ = De(t) ∈ [0.1] | Water depth (in meters) |
| Distanceᵣᵢₛₖ = Di(t) ∈ [0.1] | Distance to coastline (in kilometres) |
| Lightᵣᵢₛₖ = L(t) ∈ [0.1] | Length of day (sunrise to sunset in hours) |
| Chlorophyllᵣᵢₛₖ = C(t) ∈ [0.1] | Concentration of chlorophyll a (in mg · |
| | m⁻³) |
| Salinityᵣᵢₛₖ = Sa(t) ∈ [0.1] | Seawater surface salinity (in psu or g/kg) |

Where the above parameters are environmental parameters, and t is a unit of time, normally in hours or days. The length of day parameter could be replaced by solar irradiance or by a combination of these two parameters.

Example expressions derived and implemented for each of the parameters is shown below.

$$Water speed ( S ( t ) ) = 1 - \frac{1}{1 + {e}^{- {c}_{1} ( S ( t ) - {c}_{2} )}} \qquad ( 1 )$$

where c1 and c2 are constants.

$$Temperature ( T ( t ) ) = \frac{1}{1 + {e}^{- {c}_{3} ( T ( t ) - {c}_{4} )}} \qquad ( 2 )$$

where c3 and c4 are constants.

$$Depth ( De ( t ) ) = \{ \begin{matrix}{c}_{5} D e ( t ) + {c}_{6} & if 0 < D e ( t ) \leq - 250 m \\ 0.1 & if De ( t ) > 250 m\end{matrix} \qquad ( 3 )$$

where c5 and c6 are constants.

$$Distance ( Di ( t ) ) = \{ \begin{matrix}1 & if Di ( t ) \leq 1.852 km \\ \frac{{c}_{7}}{Di ( t )} & if Di ( t ) > 1.852 km\end{matrix} \qquad ( 4 )$$

where c7 is a constant.

$$Light ( L ( t ) ) = \{ \begin{matrix}0 & if L ( t ) < 6 h \\ {c}_{8} L ( t ) - {c}_{9} & if 6 h \leq L ( t ) < 11 h \\ 1 & if L ( t ) \geq 11 h\end{matrix} \qquad ( 5 )$$

where c8 and c9 are constants.

$$Chlorophyll ( C ( t ) ) = \frac{1}{1 + {e}^{- {c}_{10} ( C ( t ) - {c}_{11} )}} \qquad ( 6 )$$

where c10 and c11 are constants.

$$Salinity ( Sa ( t ) ) = \{ \begin{matrix}0 & if Sa ( t ) < 1 psu \\ 0.5 & if 1 < Sa ( t ) < 10 psu \\ 1 & if Sa ( t ) \geq 10 psu\end{matrix} \qquad ( 7 )$$

Similar expressions can be derived for other environmental parameters referred to herein.

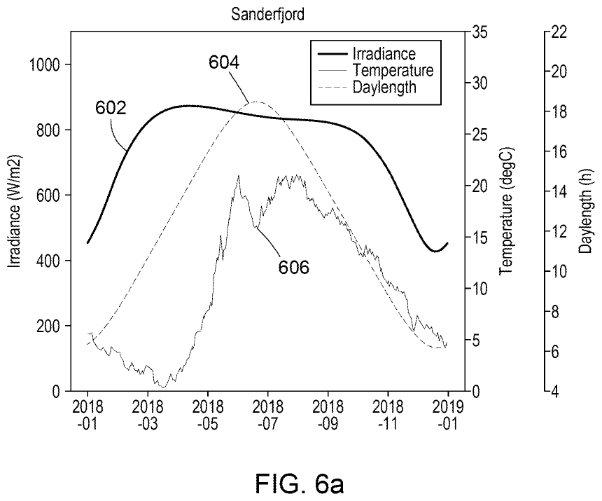

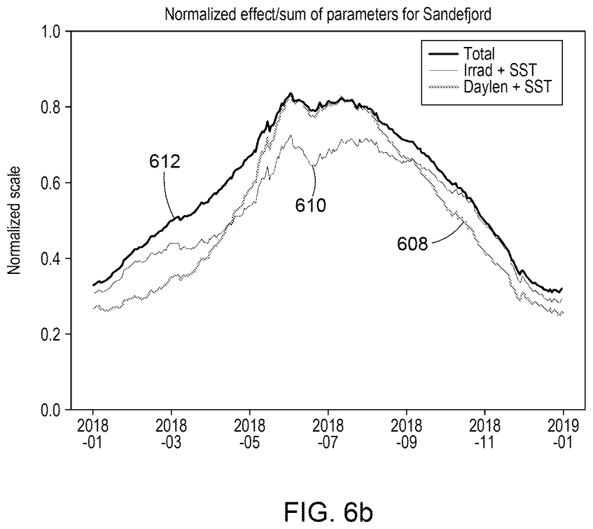

FIG. 6a illustrates how values of three example environmental parameters (solar irradiance, sea surface water temperature, and day length) vary over time in Sandefjord Norway over a 1 year period. In particular, curve 602 shows how the solar irradiance varies over the 1 year period, curve 604 shows how the day length varies over the 1 year period, and curve 606 shows how the temperature varies over the 1 year period,

FIG. 6b illustrates how the fouling value may vary over time on a normalized scale. In particular, curve 608 shows how the fouling value varies over the 1 year period when it is based on two parameters, the sea surface water temperature and day length. Curve 610 shows how the fouling value varies over the 1 year period when it is based on two parameters, the sea surface water temperature and solar irradiance. Curve 612 shows how the fouling value varies over the 1 year period when it is based on all three of the example parameters (solar irradiance, sea surface water temperature, and day length).

It will be apparent that these expressions are intended to model the contribution of each individual parameter, in a scale from 0 (low) to 1(high), to a total level of marine fouling that the surface of the stationary object is exposed to, which is defined by the fouling value in a normalized scale from 0 (low) to 1 (high). The fouling value may take any value on this normalized scale.

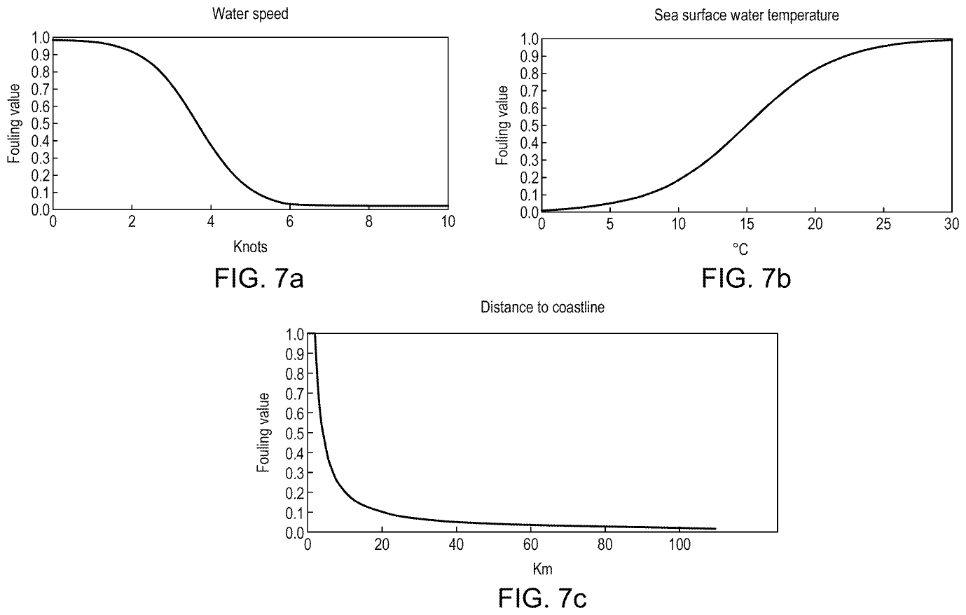

With reference to FIG. 7a, it can be seen that the contribution of the water speed parameter to the fouling value is maximum (i.e. equal to 1) when the stationary object 100 is exposed to a water speed of 0 kn, which means that the risk/contribution of fouling attachment/development on the object is maximum at that point in time. However, if the water speed is at approximately 4 kn the contribution drops to 40% (a value of 0.4 in the speed factor figure). The risk/contribution of the speed parameter is close to zero if the water speed is at 6 kn.

Regarding the contribution of the sea surface water temperature parameter to the fouling value, as shown in FIG. 7b it can be seen that the contribution of fouling development increases with temperature but not in a linear way. At low and high temperature ranges, the degree of increase is lower than at median values.

As shown in FIG. 7c, distance to coastline is a parameter whose risk/contribution of fouling attachment and development is high close to the shore but abruptly decreases as the stationary object is farther away from the coastline. The derived curve indicates that at 20 km from the coastline the contribution to the fouling value is approximately 10% (0.1 in the distance to coastline figure).

It will be apparent that the expressions provided above are merely examples. If expressions, such as those provided above, are used to model the approximate risk/contribution that each parameter provides to the overall fouling value, then the expressions may vary over time and may be improved through continuous analysis of empirical data gathered over time. Furthermore, one or more of the expressions to be used in determining the fouling value may vary in dependence on the stationary object type.

If some parameters are considered more important for the determination of the fouling value at step S402, weights may be applied to each parameter.

Thus, referring to the example parameters provided above, the total instantaneous fouling value is then, a weighted average of the different parameter risk factors, as shown in equation (8), where K is a constant and represents the weight given to each factor.

$$Fouling Value ( t ) = \frac{1}{\sum K} Water speed ( t ) ( {K}_{T} Temperature ( t ) + {K}_{De} Depth ( t ) + {K}_{Di} Distance ( t ) + {K}_{C} Chlorophyll ( t ) + {K}_{Sa} Salinity ( t ) + {K}_{L} Light ( t ) ) \qquad ( 8 )$$

Table 1 shows example weights which may be applied for each individual parameter.

TABLE 1

| Coefficient K | Weight |
|---|---|
| Temperature K_{T} | 3 |
| Water Depth K_{De} | 2 |
| Distance to coastline K_{Di} | 3 |
| Chlorophyll K_{C} | 3 |
| Salinity K_{Sa} | 1 |
| Light K_{L} | 3 |

Referring back to FIG. 4, at step S404 a fouling protection value is determined. The fouling protection value defines the surface tolerance to marine biofouling associated with a surface of the stationary object e.g. the protection given by a coating to the stationary object's surface immersed in water. As noted above, the surface of the stationary object that is immersed in water may be coated and in these scenarios the fouling protection value defines a tolerance to marine fouling associated with a surface of the coating i.e. the protection given by the coating to the stationary object's surface. Alternatively, the surface of the stationary object may not be coated and in these scenarios the fouling protection value defines a tolerance to fouling associated with a surface of the stationary object.

The fouling protection value may be prestored in memory. For example, the fouling protection value may be prestored in the local memory of the computing device or in memory of a remote computing device that is accessible by the computing device. In these implementations, the fouling protection value has been precalculated and the fouling risk determination module determines the fouling protection value by retrieving it from memory. Thus, the fouling risk determination module may not perform the calculation of the fouling protection value itself.

In other implementations, the fouling risk determination module determines the fouling protection value by calculating the fouling protection value itself.

We describe in more detail later how the fouling protection value may be calculated. The fouling protection value may be calculated in a normalized scale from 0 (low protection) to 1 (high protection). The fouling protection value may take any value on this normalized scale.

At step S405, a fouling risk value is determined using the fouling value (determined at step S402) and the fouling protection value (determined at step S404). The fouling risk value defines a level of risk of fouling on the surface of the stationary object.

For each point in time (depending on sampling period, which may for example be 1 hour) a fouling value and fouling protection value are determined. Expression (9) provided below gives an example of how the fouling risk value may be calculated as a function of the fouling value and fouling protection value.

$$Instantaneous Fouling Risk Value ( time : x ) = \frac{Fouling value ( time : x )}{Fouling value ( time : x ) + Fouling protection value ( time : x )} \qquad ( 9 )$$

It will be appreciated that other expressions to calculate the fouling risk value as a function of the fouling value and fouling protection value may also be used.

The fouling risk value may be calculated in a normalized scale from 0 (low risk) to 1 (high risk). Table 2 shows an example of the application of expression (9).

TABLE 2

| Fouling | | Fouling protection value | | | | | | | | | | |
|---|---|---|---|---|---|---|---|---|---|---|---|---|
| risk value | | 0 | 0.1 | 0.2 | 0.3 | 0.4 | 0.5 | 0.6 | 0.7 | 0.8 | 0.9 | 1 |
| Fouling | 0 | | 0.00 | 0.00 | 0.00 | 0.00 | 0.00 | 0.00 | 0.00 | 0.00 | 0.00 | 0.00 |
| value | 0.1 | 1.00 | 0.50 | 0.33 | 0.25 | 0.20 | 0.17 | 0.14 | 0.13 | 0.11 | 0.10 | 0.09 |
| | 0.2 | 1.00 | 0.67 | 0.50 | 0.40 | 0.33 | 0.29 | 0.25 | 0.22 | 0.20 | 0.18 | 0.17 |
| | 0.3 | 1.00 | 0.75 | 0.60 | 0.50 | 0.43 | 0.38 | 0.33 | 0.30 | 0.27 | 0.25 | 0.23 |
| | 0.4 | 1.00 | 0.80 | 0.67 | 0.57 | 0.50 | 0.44 | 0.40 | 0.36 | 0.33 | 0.31 | 0.29 |
| | 0.5 | 1.00 | 0.83 | 0.71 | 0.63 | 0.56 | 0.50 | 0.45 | 0.42 | 0.38 | 0.36 | 0.33 |
| | 0.6 | 1.00 | 0.86 | 0.75 | 0.67 | 0.60 | 0.55 | 0.50 | 0.46 | 0.43 | 0.40 | 0.38 |
| | 0.7 | 1.00 | 0.88 | 0.78 | 0.70 | 0.64 | 0.58 | 0.54 | 0.50 | 0.47 | 0.44 | 0.41 |
| | 0.8 | 1.00 | 0.89 | 0.80 | 0.73 | 0.67 | 0.62 | 0.57 | 0.53 | 0.50 | 0.47 | 0.44 |
| | 0.9 | 1.00 | 0.90 | 0.82 | 0.75 | 0.69 | 0.64 | 0.60 | 0.56 | 0.53 | 0.50 | 0.47 |
| | 1 | 1.00 | 0.91 | 0.83 | 0.77 | 0.71 | 0.67 | 0.63 | 0.59 | 0.56 | 0.53 | 0.50 |

The fouling risk value can be computed as a weighted average of the instantaneous fouling risk values over a certain period of time.

$$Fouling risk value ( time : x ) = {\sum }_{time : x - window size}^{time : x} [ \begin{matrix}Instantaneous fouling risk ( time : x ) \cdot w \\ ( time : x )\end{matrix} ] \qquad ( 10 )$$

where, windowsize is the number of days considered in the evaluation of the fouling risk value (e.g. three months) and w is a weight factor. Higher weight is given to recent instantaneous values and lower weight to older instantaneous values. Weight factors range between 0 and 1, and the fouling risk value should range also between 0 and 1.

Thus in some embodiments, the fouling risk value is determined based on a plurality of instantaneous fouling risk values, each of the plurality of instantaneous fouling risk values identifying a level of risk of fouling on the surface of the stationary object at a respective sampling time in a time period, each of the plurality of instantaneous fouling risk values weighted with a weight defining the recency of the sampling time.

Once the fouling risk value has been determined at step S405, the process 400 may proceed to step S407. At step S407 the fouling risk determination module outputs the fouling risk value.

In embodiments where the robot 102 comprises the fouling risk determination module 206, at step S407 the fouling risk determination module 206 outputs the fouling risk value to a remote computing device such as the computing device 106 on the stationary object, or the on-shore computing device 108, for output to a user. This enables the user to view the fouling risk value and determine whether a control action should be taken.

In embodiments where the computing device 106 on the stationary object comprises the fouling risk determination module 306, at step S407 the fouling risk determination module 306 may output the fouling risk value to a remote computing device such as the on-shore computing device 108, for output to a user. This enables the user to view the fouling risk value and determine whether a control action should be taken. Additionally or alternatively, at step S407 the fouling risk determination module 306 may output the fouling risk value via the output device 312 of the computing device 106.

In embodiments where the on-shore computing device 108 comprises the fouling risk determination module 306, at step S407 the fouling risk determination module 306 may output the fouling risk value via the output device 312 of the computing device 108.

Once the fouling risk value has been determined at step S405, the process 400 may alternatively proceed to step S406. At step S406 the fouling risk determination module identifies whether there is high risk fouling conditions by determining whether the fouling risk value exceeds a predetermined threshold. If the fouling risk value is below the predetermined threshold, this indicates that there is low risk fouling conditions and the process 400 loops back to the start where it waits for the next sampling time (i.e. waits for the sampling period to elapse).

If the fouling risk value is above the predetermined threshold, this indicates that there is high risk fouling conditions and the process 400 proceeds to step S408 where the fouling risk determination module outputs a control signal. This is described in further detail later.

We now describe how the fouling protection value may be calculated. As noted previously the fouling risk determination module may calculate the fouling protection value itself or it may retrieve the fouling protection value that has been precalculated (e.g. by another computing device).

The fouling protection value defines a tolerance to marine fouling associated with a surface of the stationary object. That is, the fouling protection value defines the surface's ability to prevent marine fouling from attaching and eventually grow onto/into an underwater area and more specifically onto/into a stationary object's parts that are immersed in water.

Fouling protection of stationary objects is mainly achieved today by applying coatings in combination with cleaning. The properties of the surface and the composition of the surface material influence the fouling protection capacity. However as noted above embodiments are not limited to monitoring the cleanliness of coated surfaces and can also be used to monitoring the cleanliness of uncoated surfaces of a stationary object that are immersed in water.

The fouling protection value may be calculated based on a value defining an attractiveness of the surface to fouling. Fouling organisms have a tendency to prefer certain types of surfaces for settlement and colonization. This is related to biological and physical factors. Thus, these characteristics and how these affect the attractiveness of a surface can be considered and modelled. The surface attractiveness (P_c) describes the tendency of marine organisms to attach to the underwater surface of the stationary object. Fouling organisms have the tendency to prefer dark, rough and porous surfaces.

The surface attractiveness (P_c) of the surface may be determined based on one or more of (i) a surface energy of the surface, (ii) a topography of the surface (e.g. the roughness and/or texture of the surface), (iii) a porosity of the surface, (iv) an elasticity of the surface, and (iv) a colour of the surface (e.g. how dark the colour of the surface is).

If some parameters are considered more important for the determination of the surface attractiveness, weights may be applied to each parameter.

Persons skilled in the art are aware of techniques to determine the above characteristics of a surface. For example, porosity can be determined by combining image analysis and microscopy (light or scanning electron) to map voids on the surface. It may also be determined according to ASTM D6583. Surface energy can be calculated based on contact angles determined by using a goniometer and different solvents. Surface roughness can be calculated based on x, y and z coordinates determined with confocal, weight light or laser microscopes or a tactile profilometer. Elasticity may be determined by Dynamic mechanical testing (DMA) or a Universal Test Machine. Dark colours are colours with low reflectance of visible light. In an RGB colour model, the darkness of a colour can be approximated by the sum of its red, green and blue values.

The value for the surface attractiveness (P_c) may be normalized and vary between 0 and 1.

One example of how the surface attractiveness P_c can be calculated is shown below:

P_c=[w_s*1/normalized surface energy]+[w_r*1/normalized roughness]+[aging effect factor] (11)

where normalized surface energy is the ratio of the coating surface energy to a reference surface energy, for example of an epoxy coating, and normalized roughness is the ratio of the coating surface roughness to a reference roughness value.

Surface attractiveness factor may also be considered time dependent and will therefore, be affected by the age of the surface. The age of the surface may be factored in using an aging effect factor as shown above, which may vary between 0 and 1.

w_s and w_r are the weight factors for normalized surface energy and normalized surface roughness.

Persons skilled in the art will appreciate that there are different classes of fouling organisms and that the surface attractiveness value P_c can be calculated considering all classes of fouling organisms or just specific types of fouling organisms.

Additionally or alternatively, the fouling protection value may be calculated based on a value defining an effect, on a surface of the stationary object, of water moving over the surface.

A strategy from preventing settlement/growth of fouling is the removal of such organisms via the mechanical forces that develop from water moving over the surface (e.g. currents). This strategy can be divided into two different approaches. One approach is to make the surface as smooth and slippery as possible so that when the water flows over the surface, the shear forces applied remove organisms attached to the surface. The other approach is to develop self-renewing surfaces which contribute to the removal of fouling settlement through film erosion and polishing.

The value (P_b) defining an effect, on the surface, of water moving over the surface may be determined using the speed of the water the stationary object is exposed to, and one or more of (i) a surface energy of the surface, (ii) a topography of the surface (e.g. the roughness and/or texture of the surface), and (iii) a porosity of the surface.

The value (P_b) defining an effect, on the surface, of water moving over the surface may be normalized and vary between 0 and 1.

In scenarios where embodiments of the present disclosure are used to monitor the cleanliness of a surface of a coating applied to the underwater parts of the stationary object 100, the value (P_b) defining an effect, on the surface, of water moving over the surface would depend on the characteristics of the coating.

As noted above, the coatings applied on the stationary object can be divided in classes depending on if the coatings are polishing or non-polishing.

For polishing coatings, the value P_b may be modelled as a function of polishing rate and surface characteristics.

P_b(time: x)=Polishing rate(time: x)+surface characteristics factor (12)

The polishing rate defines the rate at which the thickness of the coating reduces over time. The polishing rate is typically specified by the manufacturer of the coating and is typically expressed in terms of an annual polishing rate.

The polishing rate can be determined by exposing coated panels on rafts at different locations in the world. The polishing rate can be determined in laboratory test in accordance with the test method “Determination of the polishing rates of antifouling coating films on rotating disc in seawater” described in WO2019096926. Laboratory testing can be made using seawater with different temperature to determine the temperatures effect on the polishing rate. Laboratory testing can be made using different rotation speed to determine the polishing rate at different water speed. It will be appreciated that the above are provided as mere examples of how the polishing rate of a coating may be calculated, and alternative test conditions (in a laboratory or at sea, different water speeds, different sea water temperatures may be used).

The polishing rate may be normalized to a reference polishing rate, which may be technology and/or coating specific. The reference polishing rate would reflect the theoretical annual polishing rate for which the balance between diffusion of fouling control agents and leach layer thickness is maintained at an acceptable level. The leached layer is the area towards the surface where the composition has changed due to loss of water-soluble materials. The leach layer thickness can be determined with the methods described above for polishing rate.

The surface characteristics factor may be determined using one or more of (i) a surface energy of the surface. (ii) a topography of the surface (e.g. the roughness and/or texture of the surface), and (iii) a porosity of the surface.

It will be appreciated by persons skilled in the art that the surface characteristics factor will depend on the coating age and surface exposure history. By surface exposure history we refer to the cumulative amount of time in a certain period when fouling could effectively attach to the surface. This is the time when the surface is neither renewed by water moving over it at relatively high speed nor by mechanically means (with e.g. brushes, water jetting or alike).

One example of how the surface characteristics factor can be calculated is shown below:

Surface characteristic factor=_{f}*[w₁*(1/normalized surface energy)+w₂*(1/normalized roughness)+age factor] (13)

where normalized surface energy is the ratio of the coating surface energy to a reference surface energy, for example of an epoxy coating, and normalized roughness is the ratio of the coating surface roughness to a reference roughness value.

v_{f}, w₁ and w₂ are the weight factors for water speed, normalized surface energy and normalized surface roughness.

The age of the surface may be factored in using an age effect factor as shown above.

For non-polishing coatings, P_b can be modelled as function of water speed and surface characteristics (e.g. a surface characteristics factor).

The surface characteristics factor may be determined using one or more of (i) a surface energy of the surface, (ii) a topography of the surface (e.g. the roughness and/or texture of the surface), and (iii) a porosity of the surface.

For example, value (P_b) defining an effect, on the surface, of water moving over the surface can be considered maximum when the speed is above a certain threshold and minimum when speed is zero. The speed threshold can be determined experimentally as the speed at which all types of fouling can be removed from the surface. The speed threshold is species dependent and different methods can be used to determine it, e.g. ASTM D5618 for barnacles. When it comes to the dependency of P_b on surface characteristics, the latter will have an impact on the net shear forces applied to the surface.

In addition to the above, in scenarios where embodiments of the present disclosure are used to monitor the cleanliness of a surface of coating applied to the stationary object's parts underwater, and the coating contains fouling control agents, the fouling protection value may be calculated based on a value defining the effect of fouling control agents on the surface (e.g. biocides) to marine biofouling.

Fouling control agents can be any form of organic or non-organic substances, which influence, repel or act as hazardous towards fouling organisms making it difficult or even impossible to settle or survive on the surface.

The effect of the fouling control agent on marine biofouling is described by the diffusion of the latter from the coating to the surface. In broad terms, the effect of the fouling control agent (P_a) is modelled as function of (i) speed of water (ii) surface exposure history. and (iii) the age of the coating.

The value (P_a) defining the effect of the fouling control agent (P_a) may be normalized and vary between 0 and 1.

When the water speed is slow the fouling control agents diffuse to the surface and a protective layer is established. Increased water speed through e.g. currents, tide or waves transports the fouling control agents away from the surface and the protection against marine organisms is reduced.

With regards to the surface exposure history, if surface exposure is not balanced by surface renewal then this will have an impact on the effect of fouling control agents (diffusion of fouling control agents is being inhibited). An example is a biocidal self-polishing surface which needs to maintain the leach layer thickness within acceptable levels so that biocides can effectively diffuse to the surface and protect the latter. If surface exposure history is unfavorable (the speed of water has been low), then the above-mentioned balance is perturbed. A certain technology might have a better control over this balance, ensuring a more stable diffusion of the fouling control agents to the surface throughout the lifetime of the coating.

One possible way to model the effect of fouling control agents is described by the following formula:

P_a(time: x)=P_a(time: x−1)+[[1/leach layer factor(time: x)]*(mean release rate)]−(removal agent factor) (14)

Where:
P_a (time: x) is the concentration of the fouling control agent at time x;
P_a (time: x−1) is the concentration of fouling control agent at time x−1;
leach layer factor(time: x) is a factor accounting for the thickness of the leach layer, the leach layer factor can be dependent on the age of the coating and coating technology;
mean release rate is the average change in fouling control agent concentration per unit of time, the mean release rate may be estimated on the polishing rate and/or knowledge of the coating technology of the coating, alternatively the release rate may be experimentally determined using known methods (e.g. ISO10890:2010, ASTM D6442-99, ISO 15181-2, ISO 15181-3, ISO 15181-6); and
removal agent factor is a factor accounting for the diffusion of fouling control agent in the sea water, the removal agent factor may be dependent on the temperature, viscosity of the sea water and water speed.

As exemplified earlier, ideally, there should be a balance between the release of fouling control agents and surface renewal. This balance ensures minimal changes in the leach layer thickness and, therefore, easier diffusion of the fouling control agents to the surface. To account for the changes in leach layer thickness, the following formula can be used:

Leach layer factor(time: x)=leach layer factor(time: x−1)+delta (15)

where delta is a correction factor accounting for surface renewal through polishing. For polishing surfaces delta is modelled as a function of water speed. It is desirable to measure the water speed as close to the surface of the stationary object as possible. When water speed is higher than a certain threshold, delta is expected to be negative. On the contrary, when water speed is below the same threshold, this correction factor is positive, meaning that over longer periods of low water speed, leach layer thickness will increase with time. The threshold used would depend on coating technology and will reflect the minimum speed at which polishing starts. For non-polishing coatings, delta is positive and constant throughout the lifetime of the coating.

As fouling control agents reach the coating surface, these will naturally diffuse further into the sea water. To account for this, a “removal agent” factor may be used. The removal agent is a function of water speed close to the surface of the stationary object 100, so that when the water speed is lower than a certain threshold (e.g. 3 kn), the removal agent factor is small, but never zero. On the other hand, when water speed is beyond the same threshold, the removal agent factor is greater.

The effect of fouling control agent is also dependent on the agent itself. Not all fouling control agents that diffuse to the coating surface have the same protection effect. Furthermore, a coating might have several fouling control agents, and these might be effective against different fouling organisms.

To correct the fouling control agent parameter computed by the above formula, an effectiveness of the agent factor can be used which may vary between 0 and 1. Thus a final value (P_a) defining the effect of the fouling control agent at any point in time can be defined as:

P_a=agent_effectiveness_factor*P_a(time: x) (16)

An example equation for calculating the fouling protection value is shown below:

Fouling protection value=[w_a*P_a]+[w_b*P_b]+[w_c*P_c] (17)

where P_a accounts for the effect of the fouling control agent, P_b accounts for the effect of shear forces applied on the surface and P_c accounts for the effect of surface attractiveness, and w_a, w_b and w_c are weight factors.

It will be appreciated that embodiments of the present disclosure are not limited to using a fouling protection value calculated using all of these parameters.

In embodiments where the fouling protection value is calculated using more than one of these parameters, as shown in equation (17) weight factors may be used.

Weight factors may be modelled as functions of water speed and/or coating technology and the sum of w_a, w_b and w_c is proposed to be 1. For example, in the case of a polishing coating, and for a stationary object with low speed of water w_a is expected to be higher than w_b; w_c would also be of importance. In the case of a stationary object with a non-polishing surface without fouling control agents, w_a would be zero and w_c being larger than w_b.

Each of the parameters of the equation (17) may be normalized and vary between 0 and 1.

It is important to note that the fouling protection value will be different for different types of marine organisms. P_a, P_b and P_c will vary because, for example, different species will react differently to different biocides, will be easier or harder to be removed from the surface and/or will have a different tendency to attach to the latter.

An example equation for calculating a generalized fouling protection value is shown below:

Fouling protection value=Σ₁ⁱ(gᵢ·Pᵢ), (18)

where i is the number of different species of marine organisms, Pᵢ—species-specific fouling protection value and gᵢ is a weighting factor.

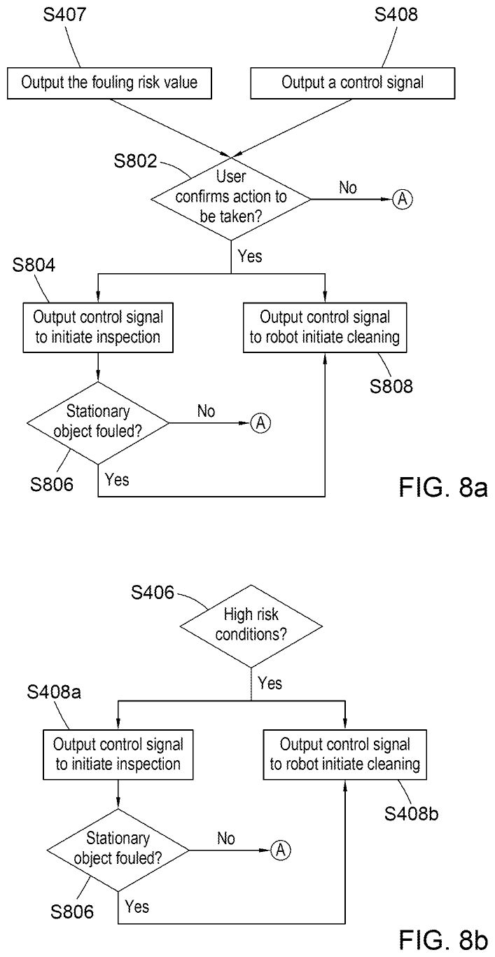

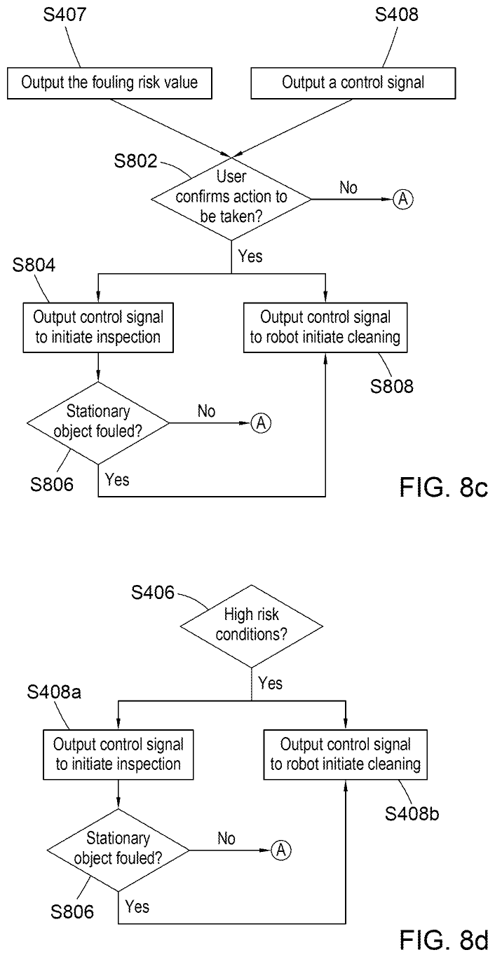

We now refer to FIGS. 8a-d which illustrate example control actions that may be performed in embodiments of the present disclosure in response to high risk fouling conditions being detected.

FIG. 8a illustrates example control actions that may be performed in embodiments of the present disclosure where the computing device 106 on the stationary object or the on-shore computing device 108 comprises the fouling risk determination module 306.

In particular, FIG. 8a illustrates example control actions that may be performed in response to user confirmation that action is to be taken in response to the cleanliness of the surface of the stationary object being monitored.

As shown, FIG. 8a includes a step of the fouling risk determination module 306 outputting a control signal that there is high risk fouling conditions which corresponds to step S408 described above. In the embodiment shown in FIG. 8a, this control signal is output to alert a user of the high risk fouling conditions. In particular, the control signal controls an output device to alert the user of the high risk fouling conditions.

In embodiments where the computing device 106 on the stationary object comprises the fouling risk determination module 306, at steps S408 the fouling risk determination module 306 may output the alert to a remote computing device such as the on-shore computing device 108, for output to a user. This enables the user to determine whether a control action should be taken. Additionally or alternatively, at steps S408 the fouling risk determination module 306 may output the alert via the output device 312 of the computing device 106 for a user on the stationary object to respond to.

In embodiments where the on-shore computing device 108 comprises the fouling risk determination module 306, at steps S408 the fouling risk determination module 306 may output the alert via the output device 312 of the computing device 108.

In response to the fouling risk determination module 306 outputting the fouling risk value at step S407, or outputting the control signal at step S408, at step S802 the fouling risk determination module 306 waits for receipt of user confirmation that action is to be taken.

The fouling risk determination module 306 may receive user confirmation that action is to be taken in response to the user supplying an input via an input device of the computing device (not shown in FIG. 3). If the control signal is output to a remote computing device, the fouling risk determination module 306 may receive user confirmation that action is to be taken in response to receiving a confirmation message received via interface 316.

If the user does not confirm that action is to be taken, the process 400 loops back to the start where it waits for the next sampling time (i.e. waits for the sampling period to elapse).

If the user confirms that action is to be taken, the fouling risk determination module 306 outputs a further control signal so that an appropriate action is made in due time. This can be implemented in various ways.

In one example, at step S804 the fouling risk determination module 306 outputs a control signal to initiate inspection of the stationary object's parts immersed in water.

The fouling risk determination module 306 may output this control signal to a robot 102 on the stationary object, or a remotely operated underwater vehicle on the stationary object, to initiate inspection of the stationary object's parts immersed in water. As will be understood, the robot 102 on the stationary object or a remotely operated underwater vehicle can carry out inspection of the stationary object's parts immersed in water by traversing the stationary object and using an inspection device (e.g. a camera) to inspect the parts immersed in water. Alternatively, the fouling risk determination module 306 may output this control signal to a remote computing device on the stationary object to alert a user to manually launch the robot 102 or a remotely operated underwater vehicle (e.g. a swimming remotely operated underwater vehicle) to inspect the stationary object's parts immersed in water. In embodiments where the on-shore computing device 108 comprises the fouling risk determination module 306, the remote computing device may correspond to the computing device 106. In embodiments where the computing device 106 comprises the fouling risk determination module 306, the remote computing device may correspond to a further computing device on the stationary object (e.g. a mobile computing device of a stationary object worker).

In another example, at step S808 the fouling risk determination module 306 outputs a control signal to the robot 102 to initiate cleaning of the surface of the stationary object immersed in water. In embodiments where the on-shore computing device 108 comprises the fouling risk determination module 306, this control signal may be sent via the computing device 106 on the stationary object. As will be understood, the robot 102 on the stationary object carries out cleaning of the stationary object's parts immersed in water by traversing the stationary object whilst using the cleaning device 208.

Referring back to step S804, if based on the inspection of the stationary object's parts immersed in water it is confirmed at step S806 that the surface of the stationary object's parts immersed in water is fouled, then the process may proceed to step S808 described above. The confirmation that the surface of the stationary object's parts immersed in water is fouled performed at step S806 may be performed automatically by the inspection vehicle (e.g. the robot 102 or a remotely operated underwater vehicle) by processing data captured by a inspection device of the inspection vehicle. For example, in the case of a camera being used to inspect the stationary object's parts immersed in water, the captured image data may be processed to detect marine fouling. Alternatively, the confirmation that the surface of the stationary object's parts immersed in water is fouled performed at step S806 may comprise the inspection vehicle transmitting data captured by a inspection device of the inspection vehicle to the computing device 106, 108. A user can then view the received data to confirm whether or not the surface of the stationary object's parts immersed in water is fouled. If the user does not confirm that the surface of the stationary object's parts immersed in water is fouled, the process 400 loops back to the start where it waits for the next sampling time (i.e. waits for the sampling period to elapse).

FIG. 8b illustrates example control actions that may be performed in embodiments of the present disclosure where the computing device 106 on the stationary object or the on-shore computing device 108 comprises the fouling risk determination module 306.

In particular, FIG. 8b illustrates example control actions that may be performed automatically (with no user involvement) in response to the cleanliness of the stationary object's parts immersed in water being monitored.

As shown in FIG. 8b, in response to the fouling risk determination module 306 determining that there is high risk fouling conditions at step S406, the fouling risk determination module 306 outputs a control signal at step S408 so that an appropriate action is made in due time.

These control actions correspond to those described with reference to FIG. 8a. Thus at steps S408 the fouling risk determination module 306 may output a control signal to initiate inspection of the stationary object's parts immersed in water, this is illustrated in FIG. 8b as steps S408a. Alternatively, at steps S408 the fouling risk determination module 306 may output a control signal to the robot 102 to initiate cleaning of the stationary object's parts immersed in water, this is illustrated in FIG. 8b as step S408b.

FIG. 8c illustrates example control actions that may be performed in embodiments of the present disclosure where the robot 102 comprises the fouling risk determination module 206.

In particular FIG. 8c illustrates example control actions that may be performed in response to user confirmation that action is to be taken in response to the cleanliness of the stationary object's parts immersed in water being monitored.

As shown, FIG. 8c includes a step of the fouling risk determination module 206 outputting a control signal that there is high risk fouling conditions which corresponds to step S408 described above. In the embodiment shown in FIG. 8c, this control signal may be output to the computing device 106 on the stationary object, or the on-shore computing device 108, to alert a user of the high risk fouling conditions. In particular, the control signal controls a remote device to alert the user of the high risk fouling conditions. This enables the user to determine whether a control action should be taken.

In response to the fouling risk determination module 206 outputting the fouling risk value at step S407, or outputting the control signal at step S408, at step S802 the fouling risk determination module 206 waits for receipt of user confirmation that action is to be taken e.g. by receiving a confirmation message received via interface 216.

If the user does not confirm that action is to be taken the process 400 loops back to the start where it waits for the next sampling time (i.e. waits for the sampling period to elapse).

If the user confirms that action is to be taken, the fouling risk determination module 206 outputs a further control signal so that an appropriate action is made in due time. This can be implemented in various ways.

In one example, at step S804 the fouling risk determination module 206 outputs a control signal to initiate inspection of stationary object's parts immersed in water. For example, the fouling risk determination module 206 outputs a control signal to activate an inspection device of the robot 102 and controls the robot 102 to travel to inspect the surface of the stationary object's parts immersed in water.

In another example, at step S808 the fouling risk determination module 206 outputs a control signal to initiate cleaning the stationary object's parts immersed in water. For example, the fouling risk determination module 206 outputs a control signal to activate the cleaning device 208 of the robot 102 and controls the robot 102 to travel to clean the surface of the stationary object's parts immersed in water.

Referring back to step S804, if based on the inspection of the stationary object's parts immersed in water it is confirmed at step S806 that the surface of the stationary object's parts immersed in water is fouled, then the process may proceed to step S808 described above. The confirmation that the surface of the stationary object's parts immersed in water is fouled performed at step S806 may be performed automatically by the robot 102 by processing data captured by an inspection device of the inspection vehicle. For example, in the case of a camera being used to inspect the stationary object's parts immersed in water, the captured image data may be processed to detect marine fouling. Alternatively, the confirmation that the surface of the stationary object's parts immersed in water is fouled performed at step S806 may comprise the robot 102 transmitting data captured by an inspection device of the robot to the computing device 106,108. A user can then view the received data to confirm whether or not the surface of the stationary object's parts immersed in water is fouled. If the user does not confirm that the surface of the stationary object's parts immersed in water is fouled, the process 400 loops back to the start where it waits for the next sampling time (i.e. waits for the sampling period to elapse).

FIG. 8d illustrates example control actions that may be performed in embodiments of the present disclosure where the robot 102 comprises the fouling risk determination module 206.

In particular FIG. 8d illustrates example control actions that may be performed automatically in response to the cleanliness of the stationary object's parts immersed in water being monitored.

As shown in FIG. 8d, in response to the fouling risk determination module 206 determining that there is high risk fouling conditions at step S406, the fouling risk determination module 206 outputs a control signal output at step S408 so that an appropriate action is made in due time.

These control actions correspond to those described with reference to FIG. 8c. Thus at step S408 the fouling risk determination module 206 may output a control signal to initiate inspection of the stationary object's parts immersed in water, this is illustrated in FIG. 8d as steps S408a. Alternatively, at step S408 the fouling risk determination module 206 may output a control signal to initiate cleaning of the stationary object's parts immersed in water, this is illustrated in FIG. 8d as step S408b.

The process 400 described above may be performed multiple times during the lifetime of the stationary object. That is, the process 400 may be performed periodically e.g. at fixed time intervals defining a sampling period or at varying time intervals.

The stationary object can be divided into different regions and each region can be assessed differently using the process 400 described above.

The results of inspections on the stationary object's parts immersed in water referred to above can be used to develop the expressions and coefficients used in one or more of steps S402, S404, and S406 in the process 400.

Furthermore, if cleaning does takes place (e.g. at step S808 or S408b referred to above), some of the parameters referred to above may be reset. For example, the fouling risk evaluation based on the fouling protection value (determined at step S404) and fouling value (determined at step S402) may be altered if cleaning takes place, e.g. by the fact that the exposure history of the coating is changed abruptly. The cleaning resets the surface condition in terms of fouling risk and also might change the coating surface itself by removing parts of the leached layer, washing out biocides etc. Thus the modeling can be altered to accommodate for that effect by increasing the fouling protection value (which has a maximum value of 1)and by reducing the fouling value (which has a minimum of zero). The fouling risk value (determined at step S405) can also be initialized from the day the cleaning took place, “forgetting” about the history thus building a new moving average of the instantaneous risk values from the day of cleaning.

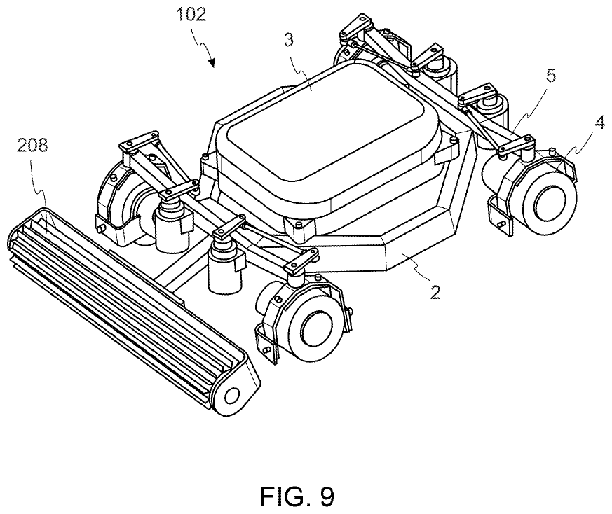

FIG. 9 illustrates an example robot 102 for cleaning the surface of stationary objects immersed in water. The wheels 4 of the robot are magnetic, in order to adhere to ferrous structures. The robot 102 is driven by the wheels 4, and the wheels 4 are driven by electric motors (not shown). In FIG. 9, the robot 102 is shown fully assembled in a perspective view. The chassis 2 of the robot 1 is a perimeter frame that holds a sealed container 3 that encloses a power supply (e.g. batteries) and may include one or more of the electrical components shown in FIG. 2. The container 3 is waterproof and sealed to prevent water ingress. Two beam “axles” 5 are fixed to the chassis 2 and these beams 5 support the wheels 4 as well as associated elements of the suspension arrangement and steering mechanisms for the wheels 4. The robot 102 includes the cleaning device 208, which may take the form of a rotary cylindrical brush, and this is also fixed to the chassis 2. It will be appreciated that FIG. 9 shows just one example form that the robot 102 may take and other examples are possible.

Generally, any of the functions described herein can be implemented using software, firmware, hardware (e.g., fixed logic circuitry), or a combination of these implementations. The terms “functionality” and “module” as used herein generally represent software, firmware, hardware, or a combination thereof. In the case of a software implementation, the functionality or module represents program code that performs specified tasks when executed on a processor (e.g. CPU or CPUs). The program code can be stored in one or more computer readable memory device (e.g. memory 210 or memory 310). The features of the techniques described below are platform-independent, meaning that the techniques may be implemented on a variety of commercial computing platforms having a variety of processors.

While the present disclosure has been particularly shown and described with reference to preferred embodiments, it will be understood to those skilled in the art that various changes in form and detail may be made without departing from the scope of the present disclosure as defined by the appendant claims.

1. A computer implemented method of monitoring the cleanliness of an underwater surface of a stationary object, the method performed on a computing device and comprising:
retrieving environmental data from memory of the computing device, the environmental data associated with environment conditions of the stationary object;
determining a fouling value indicative of a level of fouling that the surface is exposed to based on at least the environmental data;
determining a fouling protection value defining a tolerance to fouling associated with a surface of the stationary object; and
identifying a level of risk of fouling on the surface of the stationary object by determining a fouling risk value using the fouling protection value and the fouling value.

2. The method of claim 1, wherein the environmental data comprises a value associated with each of one or more environmental parameters.

3. The method of claim 2, wherein the environmental data relates to a geographical location of the stationary object.

4. (canceled).

5. The method of claim 3, wherein environmental data relating to multiple geographical locations is stored in the memory, and the environmental data relating to the geographical location of the stationary object is retrieved using the geographical location of the stationary object.

6. The method of claim 1, where the fouling value is an instantaneous fouling value indicative of a level of fouling that the surface is exposed to at a sampling time, the instantaneous fouling value determined by computing a weighted average of values of a plurality of risk parameters, the plurality of risk parameters comprising at least one environmental parameter defined in the environmental data.

7. The method of claim 1, where the fouling risk value is determined based on: (i) a plurality of instantaneous fouling risk values, each of the plurality of instantaneous fouling risk values identifying a level of risk of fouling on the surface of the stationary object at a respective sampling time in a time period, and (ii) a time factor relating to said time period.

8. The method of claim 1, further comprising identifying high risk fouling conditions by determining that the fouling risk value exceeds a predetermined threshold, and in response outputting a control signal

9. The method of claim 1, further comprising outputting the fouling risk value.

10. The method of claim 9, further comprising outputting the fouling risk value to an output device of said computing device or outputting the fouling risk value to a remote computing device.

11. (canceled).

12. The method of claim 8, wherein the method comprises outputting the control signal to a remotely operated underwater vehicle or a cleaning robot configured to clean the surface of the stationary object, to initiate inspection of the surface of the stationary object.

13. The method of claim 8, wherein the method comprises outputting the control signal to an output device of the computing device or to a remote device on said stationary object to alert a user to initiate inspection of the surface of the stationary object.

14. The method of claim 8, wherein the method comprises outputting the control signal to a cleaning robot configured to clean the surface of the stationary object, to initiate cleaning of the surface of the stationary object.

15. (canceled).

16. The method of claim 8, wherein the computing device is a cleaning robot configured to clean the surface of the stationary object, and method comprises:
outputting the control signal to an inspection device of the cleaning robot to initiate inspection of the surface of the stationary object; or
outputting the control signal to a cleaning device of the cleaning robot to initiate cleaning of the surface of the stationary object.

17. (canceled).

18. The method of claim 1, wherein the fouling protection value is determined based on a value defining an attractiveness of the surface to fouling.

19. (canceled).

20. The method of claim 1, wherein the fouling protection value is determined based on a value defining an effect, on the surface, of water moving over said surface.

21. The method of claim 20, wherein the value defining an effect, on the surface, of water moving over said surface is determined using a speed of water, and one or more of (i) a surface energy of the surface, (ii) a topography of the surface, and (iii) a porosity of the surface.

22. The method of claim 20, wherein a coating providing said surface is a polishing coating and the value defining an effect, on the surface, of water moving over said surface is determined using a polishing rate associated with said coating.

23. The method of claim 17, wherein a coating providing said surface comprises a fouling control agent, and the fouling protection value is determined based on a value defining an effect of the fouling control agent.

24. (canceled).

25. (canceled)

26. A computer-readable storage medium comprising instructions which, when executed by a processor of a computing device, cause the processor to carry out the method of claim 1.

27. A computing device for monitoring the cleanliness of an underwater surface of a stationary object, the computing device comprising a processor configured to:
retrieve environmental data from memory of the computing device, the environmental data associated with environment conditions of the stationary object;
determine a fouling value indicative of a level of fouling that the surface is exposed to based on at least the environmental data;
determine a fouling protection value defining a tolerance to fouling associated with a surface of the stationary object; and
identify a level of risk of fouling on the surface of the stationary object by determining a fouling risk value using the fouling protection value and the fouling value.
